(19) United States
(12) Patent Application Publication
(10) Pub. No.: US 2010/0216413 A1
(43) Pub. Date: Aug. 26, 2010

(54) LEAKAGE SUPPRESSING CIRCUIT

(75) Inventor: Pradeep B. Khannur, Singapore (SG)

Correspondence Address: CONNOLLY BOVE LODGE & HUTZ LLP, 1875 EYE STREET, N.W., SUITE 1100, WASHINGTON, DC, 20006, US

(73) Assignee: AGENCY FOR SCIENCE, TECHNOLOGY AND RESEARCH, Singapore (SG)

(21) Appl. No.: 12/529,164

(22) PCT Filed: Feb. 28, 2007
(86) PCT No.: PCT/SG07/00057

§ 371 Date: Mar. 8, 2010

(51) Int. Cl. H04B 1/44

(52) U.S. Cl. 455/78

(57) ABSTRACT

A leakage suppressing circuit for a communication device is provided. The leakage suppressing circuit comprises a signal transforming unit having an input for receiving an input signal, a first output and a second output, the signal transforming unit being configured such that the phase of an output signal at the first output is at least substantially the same as or at least substantially opposite to the phase of an output signal at the second output, and the power of the output signal at the first output is at least substantially equal to the power of the output signal at the second output, a first signal directing unit, a second signal directing unit, and a combining unit.

The present invention refers to a leakage suppressing circuit, to a corresponding communication device and to a corresponding method.

It is common knowledge that antennas are used in wireless communication technologies. It is also known that the use of multiple antennas provide diversity and hence better performance, but at the expense of implementation complexity.

However, due to issues of size and portability, some communication devices comprise only one antenna for both transmit and receive functions. An example of such a communication device is a portable radio frequency identification (RFID) interrogator (or reader) device. Typically, the communication device using only one antenna for both transmit and receive functions require a unit (or component), such as a circulator or a directional coupler, to separate the receive signal path from the transmit signal path in the communication device.

However, with any unit performing the function of separating the receive signal path from the transmit signal path, a leakage signal exists from the transmit signal path to the receive signal path within the said unit. As the power of the transmitted signal is typically higher than the power of the received signal, the power of the leakage signal may be comparable to the power of the received signal. Accordingly, the leakage signal may significantly degrade the ability to detect and to process the received signal.

A conventional way to solve the problem arising from the said leakage signal is by using a circuit based on a vector modulator. However, the circuit based on a vector modulator is large and bulky. In addition, the vector modulator is complicated and the components used in the said circuit are required to have a high degree of matching (see for example [1]).

Another conventional way to solve the said problem is to use a lumped constant network, in conjunction with a single pole, four throw antenna. Again, the implemented circuit is large, and the components used in the said circuit are required to have a high degree of matching (see for example [2]).

This problem arising from the said leakage signal is solved by the leakage suppressing circuit, device and method as defined in the respective independent claims.

In a first aspect of the invention, a leakage suppressing circuit for a communication device is provided wherein the circuit comprises a signal transforming unit having an input for receiving an input signal, a first output and a second output, the signal transforming unit being configured such that the phase of an output signal at the first output is at least substantially the same as or at least substantially opposite to the phase of an output signal at the second output and the power of the output signal at the first output is at least substantially equal to the power of the output signal at the second output; a first signal directing unit having a first port, a second port and a third port, the first output of the signal transforming unit being connected to said first port, and the second port being connected to an antenna for transmitting signals to and receiving signals from the antenna; a second signal directing unit having a first port, a second port and a third port, the second output of the signal transforming unit being connected to said first port, and the second port being connected to an antenna impedance simulating unit; and a combining unit having a first input coupled to the third port of the first signal directing unit, a second input coupled to the third port of the second signal directing unit, and an output; wherein the combining unit is configured such that the output of the combining unit outputs a signal by adding the signal from the first input to the signal from the second input, when the signal transforming unit is configured such that the phase of an output signal at its first output is at least substantially opposite to the phase of an output signal at its second output, and the output of the combining unit outputs a signal by subtracting the signal from the second input from the signal from the first input, when the signal transforming unit is configured such that the phase of an output signal at its first output is at least substantially the same as the phase of an output signal at its second output.

In this embodiment, the transmit signal path is along the path from the input of the signal transforming unit; via the first output of the signal transforming unit to the first port of the first signal directing unit, via the second port of the first signal directing unit to the antenna.

The receive signal path is along the path from the antenna to the second port of the first signal directing unit, via the third port of the first signal directing unit to the first input of the combining unit, to the output of the combining unit.

In this regard, the transmit signal path and the receive signal path are separated by the first signal directing unit. The leakage signal from the transmit signal path to the receive signal path, leaks from the first port of the first signal directing unit to the third port of the first signal directing unit. Accordingly, the received signal which passes through the third port of the first signal directing unit is corrupted by the leakage signal.

Illustratively, the leakage suppressing circuit generates a replica, preferably an exact replica, of the leakage signal, for negating the leakage signal, in order to obtain a clean received signal for further processing.

In the above embodiment, the replica of the leakage signal may be generated as follows.

The signal transforming unit first generates a replica of the transmit signal. The transmit signal which will be transmitted via the first signal directing unit to the antenna is referred to as the first signal. The replica of the transmit signal is referred to as the second signal. The second signal may be of the same phase or of the opposite phase as the first signal. The power of first signal may be nearly equal, preferably exactly equal, to the power of the second signal.

As mentioned above, the leakage signal is generated by the leakage of the first signal from the first port of the first signal directing unit to the third port of the first signal directing unit. In order to generate an exact replica of the leakage signal using the second signal, the second signal should be subjected to similar (preferably exactly the same) conditions which the first signal is subjected to.

In this regard, firstly, the second signal is subjected to pass through a second signal directing unit preferably having the same characteristics as those of the first signal directing unit. Preferably, the first signal directing unit and the second signal directing unit, respectively, are of the same unit type (for example, both are circulators, or both are directional couplers), are of the same model (or part number) and have the same unit specifications, for example.

Secondly, the second signal should see the same impedance when it enters the second port of the second signal directing unit, as seen by the first signal when it enters the second port of the first signal directing unit. This impedance is obtained using the antenna impedance simulating unit.

Accordingly, since there is a no signal source connected to the second port of the second signal directing unit, the signal which appears at the third port of the second signal directing unit is the replica of the leakage signal.

As mentioned earlier, the second signal may be of the same phase or of the opposite phase as the first signal, but both the first signal and the second signal should have at least substantially the same power. Accordingly, if the second signal is of the same phase as the first signal, the replica of the leakage signal, which is generated from the second signal, is also of the same phase as the leakage signal. Likewise, if the second signal is of the opposite phase to the first signal, then the replica of the leakage signal is of the opposite phase to the leakage signal.

Since the aim of the leakage suppressing circuit is to suppress (preferably, to eliminate) the leakage signal in order to obtain a clean received signal, the replica of the leakage signal may be added to or subtracted from the received signal corrupted by the leakage signal at the combining unit, depending on whether the replica of the leakage signal is of the opposite phase to or the same phase as the leakage signal, respectively.

Embodiments of the invention emerge from the dependent claims.

In one embodiment, the antenna impedance simulating circuit is a termination impedance simulating the input impedance of the antenna.

In one embodiment, the signal transforming unit comprises a balun transformer.

In one embodiment, the signal transforming unit comprises a differential amplifier.

The differential amplifier in this embodiment refers to an amplifier which has two output signals, the first output signal and the second output signal. The power of the first output signal is the same as the power of the second output signal, but the phase of the first output signal is the opposite to the phase of the second output signal.

In one embodiment, the first signal directing unit and the second signal directing unit, respectively, are each a directional coupler, a diode detector circuit, a mixer, or a circulator. For example, a circulator is a signal directing (and isolating) unit having a junction of three ports, wherein the ports are accessed in such an order that when a signal is fed into any port, the said signal is transferred to the next port.

In one embodiment, the combining unit comprises a resistive power combiner.

In one embodiment, the combining unit comprises a differential amplifier.

In a preferred embodiment, the leakage suppression circuit is implemented so as to be used in a radio frequency identification interrogator device.

In a second aspect of the invention, a communication device is provided, comprises the leakage suppressing circuit as described above.

In one embodiment, the communication device further comprises a power amplifier, wherein an output of the power amplifier is connected to the said input of the signal transforming unit.

In one embodiment, the communication device further comprises a low noise amplifier, wherein an input of a low noise amplifier is connected to the said output of the combining unit.

In a preferred embodiment, the communication device is a radio frequency identification interrogator device.

In a third aspect of the invention, a method of suppressing a leakage signal in a communication device having a transmit signal path and a receive signal path being separated by a signal directing unit, wherein a leakage signal leaks from the transmit signal path to the receive signal path within the signal directing unit, is provided. The method comprises the steps of separating a signal to be transmitted into a first signal and a second signal, wherein the phase of the first signal is at least substantially the same as or at least substantially opposite to the phase of the second signal, and the power of the first signal is at least substantially equal to the power of the second signal; transmitting the first signal via the signal directing unit to an antenna; receiving a signal from the antenna via the signal directing unit, wherein the signal outputted by the signal directing unit includes the signal received from the antenna and the leakage signal; determining a replica of the leakage signal from the second signal, and suppressing the leakage signal from the signal outputted by the signal directing unit by using the replica of the leakage signal.

Some of the advantages of the leakage suppressing circuit provided by the invention are as follows.

Firstly, the leakage suppressing circuit generates a replica, preferably an exact replica, of the leakage signal, to be used in suppressing the leakage signal which is already mixed with the received signal in order to obtain a clean received signal for further processing. Accordingly, there may be lower error rate in the information derived from the cleaned received signal, which results in a better performance of a device using the leakage suppressing circuit.

Secondly, the implemented leakage suppressing circuit is small and does not require many components. In addition, available standard components may be used, and the only component which requires some ‘matching’ to be performed is the antenna impedance simulating circuit.

In the drawings, like reference numerals generally refer to the same parts throughout the different figures. The drawings are not necessarily to scale, emphasis instead generally being placed upon illustrating the principles of the invention. In the following description, various embodiments of the invention are described with reference to the following drawings, in which:

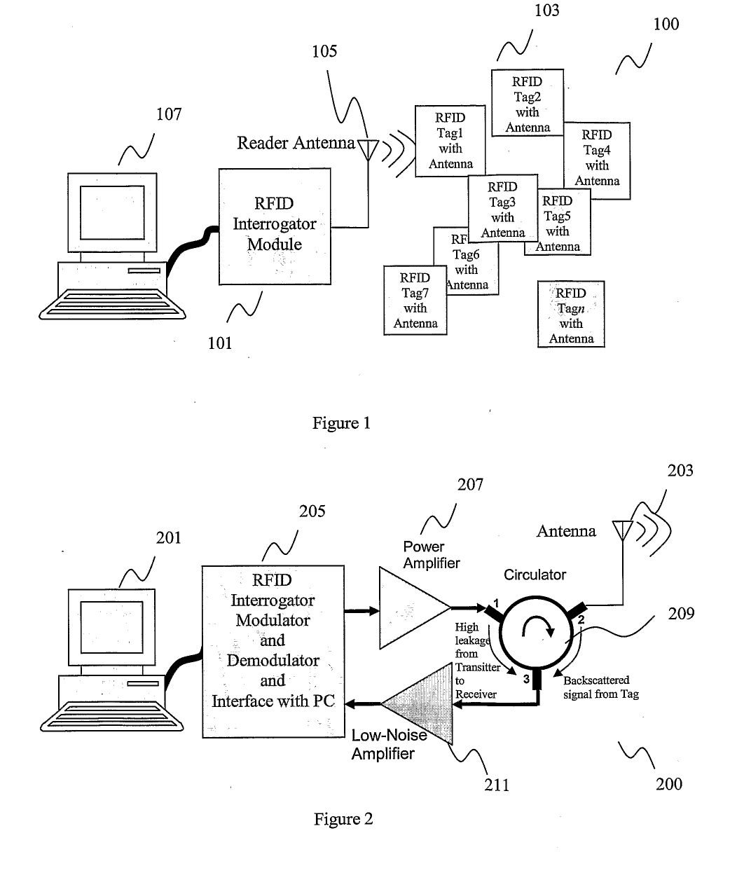

FIG. 1 shows an example of a communication system applied to an RFID communication system.

FIG. 2 shows a block diagram of a communication device in the communication system shown in FIG. 1.

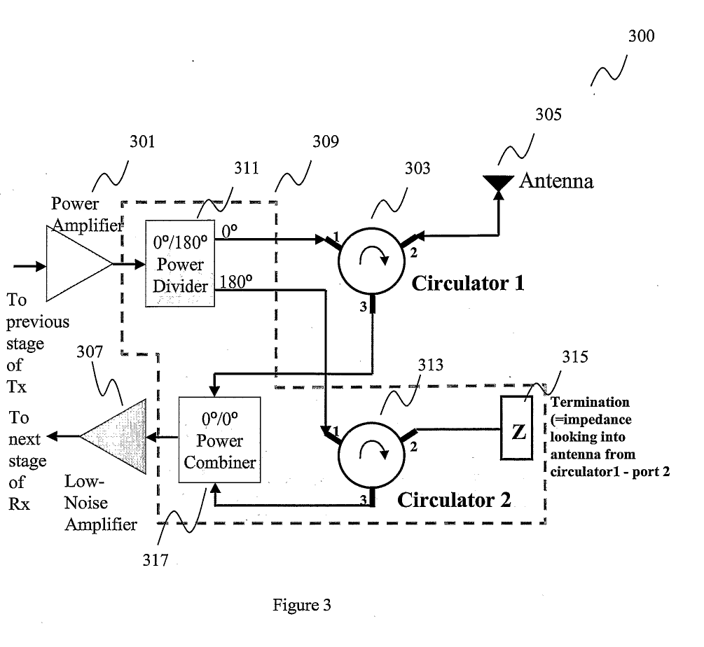

FIG. 3 shows a block diagram of an embodiment of the invention implemented using circulators.

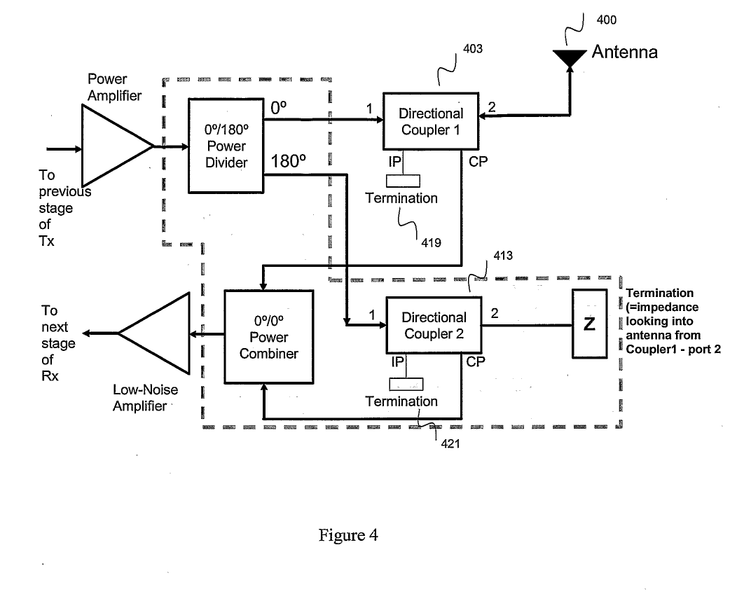

FIG. 4 shows a block diagram of an embodiment of the invention implemented using directional couplers.

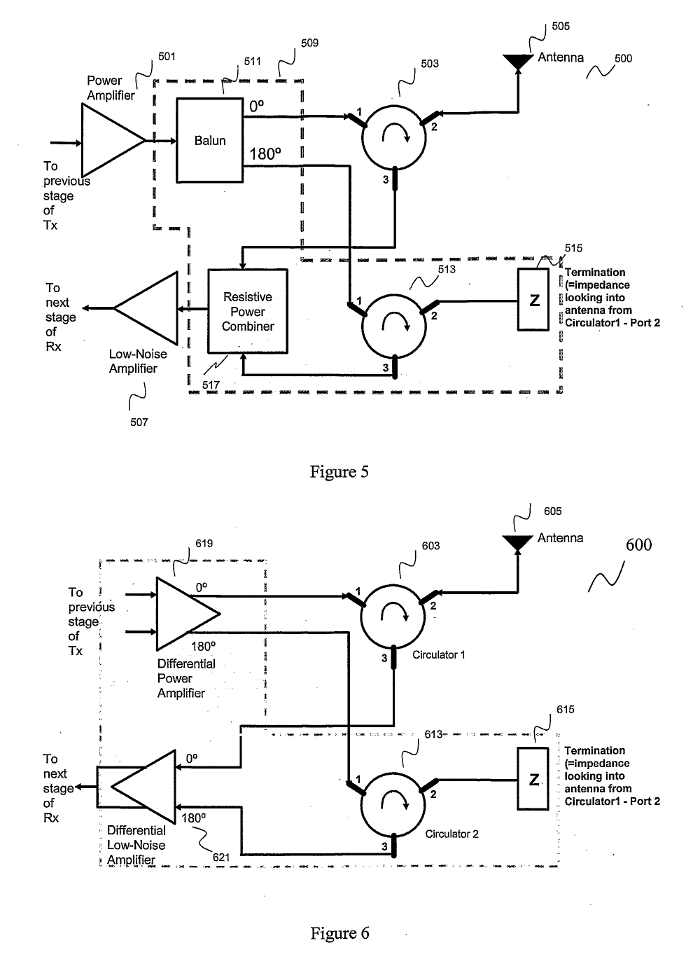

FIG. 5 shows a block diagram of another embodiment of the invention implemented using circulators.

FIG. 6 shows a block diagram of yet another embodiment of the invention implemented using circulators.

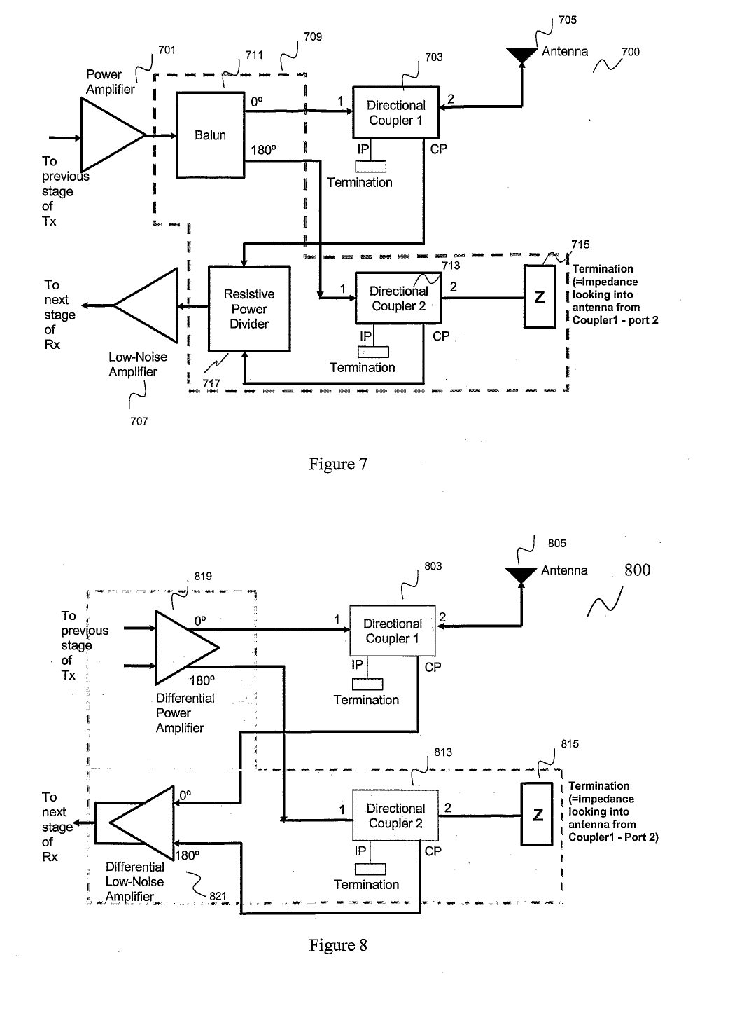

FIG. 7 shows a block diagram of another embodiment of the invention implemented using directional couplers.

FIG. 8 shows a block diagram of yet another embodiment of the invention implemented using directional couplers.

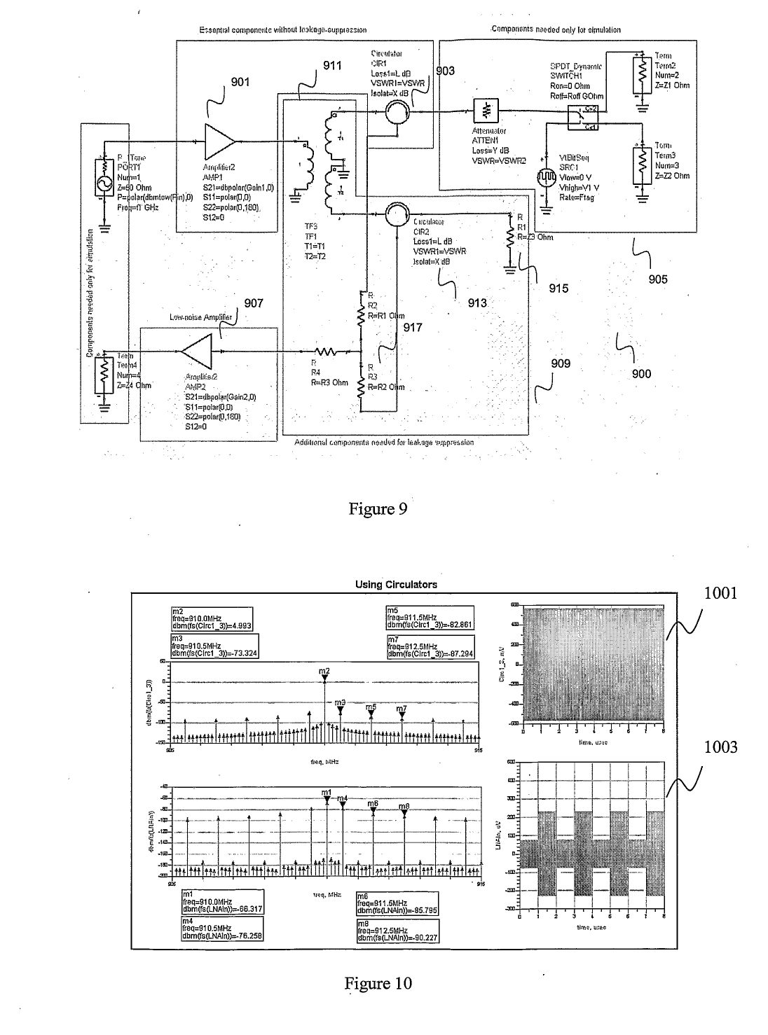

FIG. 9 shows a circuit diagram of an exemplary implementation of an embodiment of the invention using circulators.

FIG. 10 shows the performance results of an exemplary implementation of an embodiment of the invention using circulators, shown in FIG. 9.

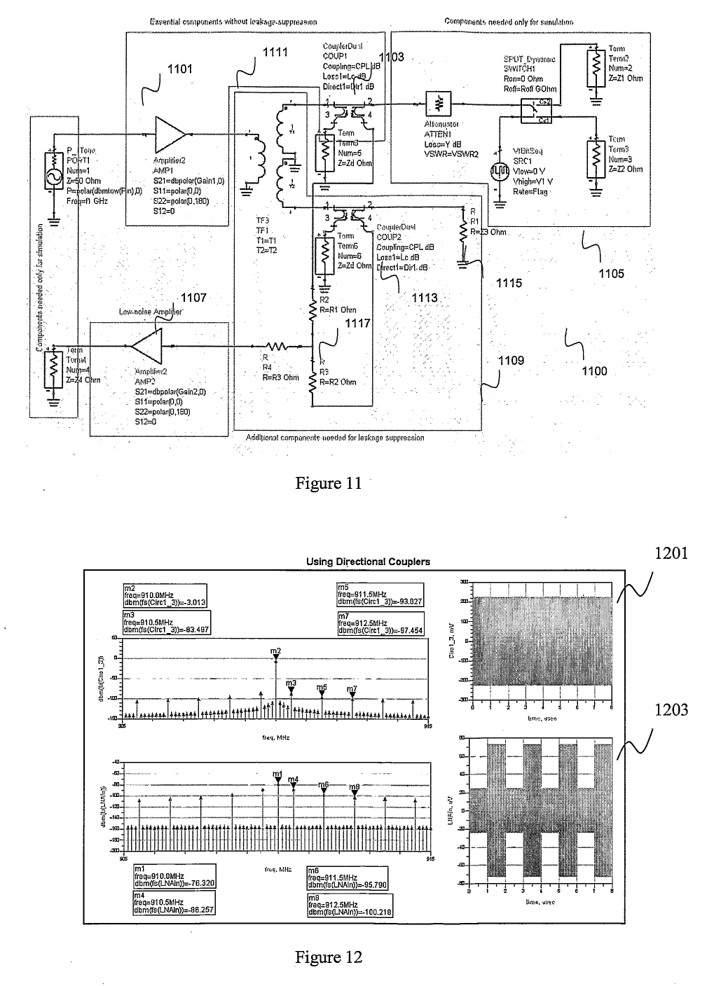

FIG. 11 shows a circuit diagram of an exemplary implementation of an embodiment of the invention using directional couplers.

FIG. 12 shows the performance results of an exemplary implementation of an embodiment of the invention using directional couplers, shown in FIG. 11.

FIG. 1 shows an example of a communication system applied to an RFID communication system.

As used herein, a communication system may be any communication system wherein a communication device in the communication system uses only one antenna for both transmit and receive functions and therefore requires a unit (or component), such as a circulator or a directional coupler, to separate the receive signal path from the transmit signal path in the communication device. An example of the communication device is an RFID interrogator device, as shown in FIG. 1. Another example of the communication device may be a ‘direct conversion’ communication device, typically used in a time division duplex (TDD) type wireless communication systems.

In this illustration, the communication system is described using an RFID communication system 100 as an example. Accordingly, the communication device is an RFID interrogator device 101.

The RFID communication system 100 comprises an RFID interrogator device 101 as the communication device and at least one RFID tag 103. The RFID interrogator device 101 uses only one antenna 105, for both transmit and receive functions. The RFID interrogator device 101 may also be connected to, for example, a computer 107, which may be used to store the information obtained by the RFID interrogator device 101.

FIG. 2 shows a block diagram of a communication device 101 in the communication system shown in FIG. 1.

In this illustration, the communication device 101 is described using an RFID interrogator as an example.

A comparison between FIG. 1 and FIG. 2 indicates that the computer 201 and the antenna 203 according to FIG. 2 respectively correspond to the computer 107 and the antenna 105 according to FIG. 1. Accordingly, the RFID interrogator device (communication device 101) comprises the components between the computer 201 and the antenna 203, namely, an RFID baseband processing component (including modulator and demodulator) 205, a power amplifier 207, a circulator 209 and a low noise amplifier 211.

The signal flow on the transmit signal path may be described as follows.

A signal to be transmitted, from the RFID baseband processing component 205, is fed to the input of the power amplifier 207. The signal at the output of the power amplifier 207 is fed to port 1 of circulator 209.

As mentioned earlier, the circulator 209 is a signal directing (and isolating) unit having a junction of three ports, wherein the ports are accessed in such an order that when a signal is fed into any port, the said signal is transferred to the next port. As shown in FIG. 2, the said order of circulator 209 is in a clockwise direction, which means that a signal fed into port 1 of circulator 209 is transferred to port 2 of circulator 209. Similarly, a signal fed into port 2 of circulator 209 is transferred to port 3 of circulator 209. Since there is no signal fed into port 3 of circulator 209, no signal is transferred to port 1 of circulator 209.

With regard to the transmit signal path, the signal fed to port 1 of circulator 209 is transferred to port 2 of circulator 209. The signal at port 2 of circulator 209 is subsequently transmitted via the antenna 203.

The signal flow on the receive signal path may be described as follows.

The received signal at the antenna 203 is passed to port 2 of circulator 209. From the functions of the circulator 209 described earlier, the received signal is transferred from port 2 of circulator 209 to port 3 of circulator 209.

Here, it can be seen that the circulator 209 is the component performing the function of separating the received signal path from the transmit signal path.

In view of the functions of the circulator 209, it can be seen that a leakage signal exists from port 1 of circulator 209 to port 3 of circulator 209.

Accordingly, the signal output from port 3 of circular 209 is the received signal mixed with the leakage signal. The signal output from port 3 of circulator 209 is fed to the input of the low noise amplifier 211. The signal from the output of the low noise amplifier 211 is then passed on to the RFID baseband processing component 205 for further processing.

With regard to the leakage signal, it can be seen that the power of the leakage signal is dependent on the power of the transmitted signal. As the power of the transmitted signal is typically higher than the power of the received signal, the power of the leakage signal may be comparable to the power of the received signal. Accordingly, the leakage signal may significantly degrade the ability to detect and to process the received signal.

Further, it should be noted that the signal directing function performed by the circulator 209 may be alternatively provided by other signal directing components, including a directional coupler, a diode detector, a mixer, or the like.

FIG. 3 shows a block diagram 300 of an embodiment of the invention implemented using circulators 303 and 313.

The block diagram 300 shows a power amplifier 301, circulator 1 303, one antenna 305, a low noise amplifier 307 and a leakage suppressing circuit block 309.

When the embodiment shown in FIG. 3 is compared to the embodiment shown in FIG. 2, it can be seen that both embodiments have the power amplifier (301, 207), the circulator (303, 209), the one antenna (305, 203) and the low noise amplifier (307, 211). It can also be seen that the main difference between the embodiment shown in FIG. 3 and the embodiment shown in FIG. 2 is the leakage suppressing circuit block 309.

The leakage suppressing circuit block 309 comprises a 0°/180° power divider 311, circulator 2 313, an antenna impedance simulating circuit 315 and a 0°/0° power combiner 317.

In the embodiment shown in FIG. 3, the transmit signal path is similar to that of the embodiment shown in FIG. 2, except now, the transmit signal path passes from the output of the power amplifier 301 to the input of the 0°/180° power divider 311 and from the first output of the 0°/180° power divider 311 to port 1 of circular 1 303.

In this regard, the 0°/180° power divider 311 takes an input signal from the power amplifier 301 and separates the input signal into two output signals. The first output signal and the second output signal has the same power but opposite phases (i.e., they have a phase difference of)180°. The 0°/180° power divider 311 described here is an example of a signal transforming unit mentioned earlier.

The signal at the second output of the 0°/180° power divider 311 is therefore a replica of the transmit signal, but with a phase difference of 180°. This signal is used to generate a replica of the leakage signal. For this purpose, circulator 2 313 and an antenna impedance simulating circuit 315 are used to simulate the characteristics of the circulator 1 303 and the one antenna 305.

In more detail, the second output of the 0°/180° power divider 311 is connected to port 1 of circulator 2 313. The signal at port 1 of circulator 2 313 is transferred to port 2 of circulator 2 and is “transmitted” at the antenna impedance simulating circuit 315.

In this regard, the antenna impedance simulating circuit 315 is a termination impedance simulating the input impedance of the antenna. A suitable value of the termination impedance is determined accordingly for each device which uses the leakage suppressing circuit.

In view of the function of the antenna impedance simulating circuit, it can be seen that no signal is received by the antenna impedance simulating circuit 315. Accordingly, no signal is transferred from port 2 of circulator 2 313 to port 3 of circulator 2 313. Therefore, the only signal at port 3 of circulator 2 313 is the replica of the leakage signal (generated from the replica of the transmit signal), which should have a phase difference of 180° from the actual leakage signal.

In the embodiment shown in FIG. 3, the receive signal path is also similar to that of the embodiment shown in FIG. 2, except now, the receive signal path passes from port 3 of circulator 1 303 to the first input of the 0°/0° power combiner 317, and from the output of the 0°/0° power combiner 317 to input of the low noise amplifier 307.

In this regard, the 0°/0° power combiner 317 takes two input signals, combines the input signals and output one signal. The 0°/0° power combiner 317 described here is an example of a combining unit mentioned earlier.

The signal at the second input of the 0°/0° power combiner 317 is the signal output from port 3 of circulator 2 313, namely, the replica of the leakage signal (but with a phase difference of)180°. This signal is used to suppress the leakage signal in the signal from port 3 of circulator 1 303.

As explained earlier, the leakage suppressing circuit block 309 essentially aims to generate an exact replica of the leakage signal, to be used in suppressing the leakage signal which is already mixed with the received signal, in order to obtain a clean received signal. In this manner, with the leakage suppressing circuit, a clean received signal may be obtained before further processing by the low noise amplifier 307. Accordingly, there is a low error rate, if any, in the information derived from the received signal, which results in a better performance of a device using the leakage suppressing circuit. In this case, the device using the leakage suppressing circuit is a RFID interrogator device.

In view of the above, it is therefore possible to modify the leakage suppressing circuit by using, for example, a 0°/0° power divider and a 0°/180° power combiner, instead of a 0°/180° power divider and a 0°/0° power combiner.

Other components of the leakage suppressing circuit may also be replaced by alternative components. For example, circulator 1 303 and circulator 2 313 may be replaced by directional couplers, as shown in the embodiment illustrated in FIG. 4.

FIG. 4 shows a block diagram 400 of an embodiment of the invention implemented using directional couplers 403 and 413. As mentioned earlier, the only difference between the respective embodiments shown in FIG. 3 and FIG. 4 is that the circulators used in the embodiment shown in FIG. 3 are replaced by directional couplers used in the embodiment shown in FIG. 4.

In this regard, it should be noted that a directional coupler (403, for example) is typically used with its isolation port connected to a termination (419, for example), as shown in FIG. 4.

FIG. 5 shows a block diagram 500 of another embodiment of the invention implemented using circulators 503 and 513.

The block diagram 500 shows a power amplifier 501, circulator 1 503, one antenna 505, a low noise amplifier 507 and the leakage suppressing circuit block 509. In this case, the leakage suppressing circuit block 509 includes a balun transformer 511, circulator 2 513, an antenna impedance simulating circuit 515 and a resistive power combiner 517.

The labeled items in FIG. 5, 501-517, correspond to the respective labeled items in FIG. 3, 301-317.

In this case, the balun transformer 511 and the resistive power combiner 517 are the respective exemplary implementations of the 0°/180° power divider 311 and 0°/0° power combiner 317 of the embodiment shown in FIG. 3.

In an alternative implementation, the balun transformer 511 may be replaced by a two way 180° power divider, or a 180° hybrid power divider, for example. In another alternative implementation, the resistive power combiner 517 may be replaced by other means of achieving in-phase power combining, such as Wilkinson power combining, for example.

FIG. 6 shows a block diagram 600 of yet another embodiment of the invention implemented using circulators 603 and 613.

The block diagram 600 shows circulator 1 603, one antenna 605 and the leakage suppressing circuit block 609. In this case, the leakage suppressing circuit block 609 includes circulator 2 613, an antenna impedance simulating circuit 615, a differential power amplifier 619 and a differential low noise amplifier 621.

When the embodiment shown in FIG. 6 is compared to the embodiment shown in FIG. 3, it can be seen that the power amplifier 301 and the 0°/180° power divider 311 of the embodiment shown in FIG. 3 are replaced by the differential power amplifier 619, and the low noise amplifier 307 and the 0°/0° power combiner 317 of the embodiment shown in FIG. 3 are replaced by the differential low noise amplifier 621.

It should be noted in this illustration that the differential low noise amplifier 621 has its differential outputs connected together. This is because one input of the differential low noise amplifier 621 is fed by a signal comprising the leakage signal and the received signal from the antenna, and the other input of the differential low noise amplifier 621 is fed by the replica of the leakage signal (with a 180° phase shift compared to the actual leakage signal).

Accordingly, when the differential outputs of the differential low noise amplifier 621 are connected together, the two leakage signals will cancel out each other, leaving only the received signal from the antenna, which is the desired signal.

FIG. 7 shows a block diagram 700 of an embodiment of the invention implemented using directional couplers 703 and 713.

The block diagram 700 shows a power amplifier 701, directional coupler 1 703, one antenna 705, a low noise amplifier 707 and the leakage suppressing circuit block 709. In this case, the leakage suppressing circuit block 709 includes a balun transformer 711, directional coupler 2 713, an antenna impedance simulating circuit 715 and a resistive power combiner 717.

As mentioned earlier, the only difference between the respective embodiments shown in FIG. 5 and FIG. 7 is that the circulators 503 and 513 of the embodiment shown in FIG. 5 are replaced by directional couplers 703 and 713 of the embodiment shown in FIG. 7.

FIG. 8 shows a block diagram 800 of an embodiment of the invention implemented using directional couplers 803 and 813.

The block diagram 800 shows circulator 1 803, one antenna 805 and the leakage suppressing circuit block 809. In this case, the leakage suppressing circuit block 809 includes circulator 2 813, an antenna impedance simulating circuit 815, a differential power amplifier 819 and a differential low noise amplifier 821.

As mentioned earlier, the only difference between the respective embodiments shown in FIG. 6 and FIG. 8 is that the circulators of the embodiment shown in FIG. 6 are replaced by directional couplers of the embodiment shown in FIG. 8.

FIG. 9 shows a circuit diagram 900 of an exemplary implementation of an embodiment of the invention, using circulators 903 and 913.

The circuit diagram 900 shows a power amplifier 901, circulator 1 903, an antenna simulating circuit 905, a low noise amplifier 907 and the leakage suppressing circuit block 909. The leakage suppressing circuit block 909 includes a balun transformer 911, circulator 2 913, an antenna impedance simulating circuit 915 and a resistive power combiner 917.

The labeled items in FIG. 9, 901-917, correspond to the respective labeled items in FIG. 5, 501-517. In this case, as the circuit is used for simulation purposes, the one antenna 505 of the embodiment shown in FIG. 5 has been replaced by the antenna simulation circuit 905.

FIG. 10 shows the performance results of an exemplary implementation of an embodiment of the invention shown in FIG. 9.

The performance results of the RFID interrogator device, without and with the leakage suppression circuit shown in FIG. 9 are respectively labeled as 1001 and 1003. It can be seen that less noise is observed in the graph labeled 1003 as compared to the graph labeled 1001. Accordingly, a cleaner received signal is obtained using the circuit shown in FIG. 9.

FIG. 11 shows a circuit diagram 1100 of an exemplary implementation of an embodiment of the invention, using directional couplers 1103 and 1113.

The block diagram 1100 shows a power amplifier 1101, directional coupler 1 1103, an antenna simulating circuit 1105, a low noise amplifier 1107 and the leakage suppressing circuit block 1109. The leakage suppressing circuit block 1109 includes a balun transformer 1111, directional coupler 2 1113, an antenna impedance simulating circuit 1115 and a resistive power combiner 1117.

The labeled items in FIG. 11, 1101-1117, correspond to the respective labeled items in FIG. 7, 701-717. In this case, as the circuit is used for simulation purposes, the one antenna 705 of the embodiment shown in FIG. 7 has been replaced by an antenna simulation circuit 1105.

FIG. 12 shows the performance results of an exemplary implementation of an embodiment of the invention shown in FIG. 11.

The performance results of the RFID interrogator device, without and with the leakage suppression circuit shown in FIG. 11 are respectively labeled as 1201 and 1203. It can be seen that less noise is observed in the graph labeled 1203 as compared to the graph labeled 1201. Accordingly, a cleaner received signal is obtained using the circuit shown in FIG. 11.

While the invention has been particularly shown and described with reference to specific embodiments, it should be understood by those skilled in the art that various changes in form and detail may be made therein without departing from the spirit and scope of the invention as defined by the appended claims. The scope of the invention is thus indicated by the appended claims and all changes which come within the meaning and range of equivalency of the claims are therefore intended to be embraced.

In this document, the following publications are cited:

### [1] WO 2005/109500 A2

[2] U.S. Pat. No. 6,686,830 B1

1. A leakage suppressing circuit for a communication device, comprising:
a signal transforming unit having an input for receiving an input signal, a first output and a second output, the signal transforming unit being configured such that
the phase of an output signal at the first output is at least substantially the same as or at least substantially opposite to the phase of an output signal at the second output, and
the power of the output signal at the first output is at least substantially equal to the power of the output signal at the second output;
a first signal directing unit having a first port, a second port and a third port, the first output of the signal transforming unit being connected to said first port, and the second port being connected to an antenna for transmitting signals to and receiving signals from the antenna;
a second signal directing unit having a first port, a second port and a third port, the second output of the signal transforming unit being connected to said first port, and the second port being connected to an antenna impedance simulating unit; and
a combining unit having a first input coupled to the third port of the first signal directing unit, a second input coupled to the third port of the second signal directing unit, and an output, wherein the combining unit is configured such that
the output of the combining unit outputs a signal by adding the signal from the first input to the signal from the second input, when the signal transforming unit is configured such that the phase of an output signal at its first output is at least substantially opposite to the phase of an output signal at its second output; and
the output of the combining unit outputs a signal by subtracting the signal from the second input from the signal from the first input, when the signal transforming unit is configured such that the phase of an output signal at its first output is at least substantially the same as the phase of an output signal at its second output.

2. The leakage suppressing circuit of claim 1, wherein the antenna impedance simulating unit is a termination impedance simulating the input impedance of the antenna.

3. The leakage suppressing circuit of claim 1, wherein the signal transforming unit comprises a balun transformer.

4. The leakage suppressing circuit of claim 1, wherein the signal transforming unit comprises a differential amplifier.

5. The leakage suppressing circuit of claim 1, wherein the first signal directing unit and the second signal directing unit, respectively, are each a directional coupler, a diode detector circuit, a mixer, or a circulator.

6. The leakage suppressing circuit of claim 1, wherein the combining unit comprises a resistive power combiner.

7. The leakage suppressing circuit of claim 1, wherein the combining unit comprises a differential amplifier.

8. The leakage suppressing circuit of claim 1, wherein the circuit is implemented so as to be used in a radio frequency identification interrogator device.

9. A communication device comprising:
a leakage suppressing circuit device, comprising:
a signal transforming unit having an input for receiving an input signal, a first output and a second output, the signal transforming unit being configured such that
the phase of an output signal at the first output is at least substantially the same as or at least substantially opposite to the phase of an output signal at the second output, and
the power of the output signal at the first output is at least substantially equal to the power of the output signal at the second output;
a first signal directing unit having a first port, a second port and a third port, the first output of the signal transforming unit being connected to said first port, and the second port being connected to an antenna for transmitting signals to and receiving signals from the antenna;
a second signal directing unit having a first port, a second port and a third port, the second output of the signal transforming unit being connected to said first port, and the second port being connected to an antenna impedance simulating unit; and
a combining unit having a first input coupled to the third port of the first signal directing unit, a second input coupled to the third port of the second signal directing unit, and an output, wherein the combining unit is configured such that
the output of the combining unit outputs a signal by adding the signal from the first input to the signal from the second input, when the signal transforming unit is configured such that the phase of an output signal at its first output is at least substantially opposite to the phase of an output signal at its second output; and
the output of the combining unit outputs a signal by subtracting the signal from the second input from the signal from the first input, when the signal transforming unit is configured such that the phase of an output signal at its first output is at least substantially the same as the phase of an output signal at its second output.

10. The communication device of claim 9, further comprising a power amplifier, wherein an output of the power amplifier is connected to the said input of the signal transforming unit.

11. The communication device of claim 9, further comprising a low noise amplifier, wherein an input of a low noise amplifier is connected to the said output of the combining unit.

12. The communication device of claim 9, wherein the communication device is a radio frequency identification interrogator device.

13. A method of suppressing a leakage signal in a communication device, having a transmit signal path and a receive signal path being separated by a signal directing unit, wherein a leakage signal leaks from the transmit signal path to the receive signal path within the signal directing unit, the method comprising the steps of:
separating a signal to be transmitted into a first signal and a second signal, wherein
the phase of the first signal is at least substantially the same as or at least substantially opposite to the phase of the second signal; and
the power of the first signal is at least substantially equal to the power of the second signal;
transmitting the first signal via the signal directing unit to an antenna;
receiving a signal via the signal directing unit, wherein the signal outputted by the signal directing unit includes the signal received from the antenna and the leakage signal;
determining a replica of the leakage signal from the second signal; and
suppressing the leakage signal from the signal outputted by the signal directing unit by using the replica of the leakage signal.
